(19) United States
(12) Patent Application Publication
(10) Pub. No.: US 2025/0233963 A1
(43) Pub. Date: Jul. 17, 2025

(54) IMAGE DISPLAY METHOD, APPARATUS, DEVICE AND STORAGE MEDIUM

(71) Applicants: Beijing Zitiao Network Technology Co., Ltd., Beijing (CN); LEMON INC., Grand Cayman (KY)

(72) Inventors: Zixi LEI, Beijing (CN); Can JIN, Los Angeles, CA (US)

(21) Appl. No.: 19/016,819

(22) Filed: Jan. 10, 2025

(30) Foreign Application Priority Data
Jan. 12, 2024 (CN) 202410051995.8

(51) Int. Cl. H04N 9/31; G06T 5/20; G06T 5/92; G06T 5/94; G06T 7/90

(52) U.S. Cl. CPC H04N 9/31; G06T 5/20; G06T 5/92; G06T 5/94; G06T 7/90; G06T 2207/10024; G06T 2207/20012

(57) ABSTRACT

Embodiments of the present application provide an image display method, apparatus, device and storage medium. The method comprises: determining, according to a pixel brightness of a to-be-displayed image, a corresponding adaptive brightness mapping relationship that makes a difference between the pixel brightness of a non-low-brightness pixel area of the to-be-displayed image after being displayed through an optical imaging system and an ideal brightness of the non-low-brightness pixel area that is not displayed through the optical imaging system less than a preset brightness difference; and transforming the pixel brightness of the to-be-displayed image according to the adaptive brightness mapping relationship, and displaying the transformed to-be-displayed image through the optical imaging system.

### CROSS REFERENCE TO RELATED APPLICATIONS

This present application claims the benefit of priority to Chinese Application No. 202410051995.8, filed on Jan. 2, 2024, the entire contents of which are incorporated herein by reference.

### TECHNICAL FIELD

Embodiments of the present application relate to the technical field of image processing, and in particular, to an image display method, apparatus, device and storage medium.

### BACKGROUND

For any image, it is usually displayed using a display panel of an optical imaging device, so that users can visually browse the corresponding image.

### SUMMARY

The embodiments of the present application provide an image display method, apparatus, device and storage medium.

In a first aspect, an embodiment of the present application provides an image display method, comprising:
determining, according to a pixel brightness of a to-be-displayed image, a corresponding adaptive brightness mapping relationship that makes a difference between the pixel brightness of a non-low-brightness pixel area of the to-be-displayed image after being displayed through an optical imaging system and an ideal brightness of the non-low-brightness pixel area that is not displayed through the optical imaging system less than a preset brightness difference;
transforming the pixel brightness of the to-be-displayed image according to the adaptive brightness mapping relationship, and displaying the transformed to-be-displayed image through the optical imaging system.

In a second aspect, an embodiment of the present application provides an image display apparatus, comprising:
a mapping relationship determination module configured to determine, according to a pixel brightness of a to-be-displayed image, a corresponding adaptive brightness mapping relationship that makes a difference between the pixel brightness of a non-low-brightness pixel area of the to-be-displayed image after being displayed through an optical imaging system and an ideal brightness of the non-low-brightness pixel area that is not displayed through the optical imaging system less than a preset brightness difference;
an image display module configured to transform the pixel brightness of the to-be-displayed image according to the adaptive brightness mapping relationship, and display the transformed to-be-displayed image through the optical imaging system.

In a third aspect, an embodiment of the present application provides an electronic device, comprising:
a processor and a memory, the memory being configured to store a computer program, the processor being configured to call and run the computer program stored in the memory to perform the image display method provided in the first aspect of the present application.

In a fourth aspect, an embodiment of the present application provides a computer-readable storage medium configured to store a computer program, wherein the computer program causes a computer to perform the image display method provided in the first aspect of the present application.

In a fifth aspect, an embodiment of the present application provides a computer program product, which includes a computer program/instructions causing a computer to perform the image display method provided in the first aspect of the present application.

### BRIEF DESCRIPTION OF THE DRAWINGS

In order to more clearly illustrate the technical solutions in the embodiments of the present application, the accompanying drawings required to be used in the description of the embodiments are briefly introduced below, and it is obvious that the drawings in the description below are only some embodiments of the present application, and it is obvious for those skilled in the art that other drawings can be obtained according to the drawings without creative efforts.

FIG. 1 is a flowchart of an image display method shown in an embodiment of the present application;

FIG. 2 is an exemplary schematic diagram of a brightness mapping relationship in four different cases related to image display shown in an embodiment of the present application;

FIG. 3 is a method flowchart of a determining process of an adaptive brightness mapping relationship shown in an embodiment of the present application;

FIG. 4 is a method flowchart of a display process of a to-be-displayed image shown in an embodiment of the present application;

FIG. 5 is a principle block diagram of an image display apparatus shown in an embodiment of the present application;

FIG. 6 is a schematic block diagram of an electronic device shown in an embodiment of the present application.

### DETAILED DESCRIPTION

The technical solutions in the embodiments of the present application will be clearly and completely described below with reference to the drawings in the embodiments of the present application, and it is obvious that the described embodiments are only a part of the embodiments of the present application, and not all of the embodiments. All other embodiments, which can be obtained by a person skilled in the art without making any creative effort based on the embodiments in the present application, belong to the protection scope of the present application.

It should be noted that the terms “first,” “second,” and the like in the description and claims of the present application and in the drawings described above are used for distinguishing between similar elements and not necessarily for describing a particular sequential or chronological order. It is to be understood that the data so used is interchangeable under appropriate circumstances such that the embodiments of the application described herein are capable of operation in other sequences than those illustrated or described herein. Moreover, the terms “comprises,” “comprising,” and any variation thereof, are intended to cover a non-exclusive inclusion, such that a process, method, system, article, or server that include a list of steps or elements is not necessarily limited to those steps or elements expressly listed, but may include other steps or elements not expressly listed or inherent to such process, method, article, or apparatus.

In an embodiment of the present application, the word “exemplary” or “such as” is used to indicate that, for example, illustration or description, any embodiment or aspect described as “exemplary” or “such as” in an embodiment of the present application should not be construed as preferred or advantageous over other embodiments or aspects. Rather, use of the word “exemplary” or “such as” is intended to present relevant concepts in a concrete fashion.

In order to solve the problem that the image quality is degraded due to the reduction of an in-eye contrast after an image is displayed through an optical imaging system, the present application presents the following inventive concept: determining a corresponding adaptive brightness mapping relationship according to a pixel brightness of a to-be-displayed image, transforming a pixel color of the to-be-displayed image accordingly, and displaying the transformed to-be-displayed image through the optical imaging system, so that a difference between the pixel brightness of a non-low-brightness pixel area of the to-be-displayed image after being displayed through the optical imaging system and an ideal brightness of the non-low-brightness pixel area that is not displayed through the optical imaging system is less than a preset brightness difference, thereby ensuring that the image quality effect of the non-low-brightness pixel area of the to-be-displayed image after being displayed through the optical imaging system can be as close as possible to the ideal image quality effect of the to-be-displayed image, eliminating the image quality degradation effect due to the reduction of the in-eye contrast when the non-low-brightness pixel area of the to-be-displayed image is displayed through the optical imaging system, realizing efficient and clear display of the to-be-displayed image through the optical imaging system, and improving the overall image quality after image display.

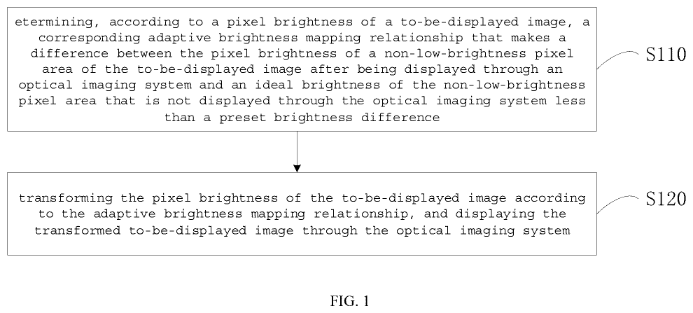

FIG. 1 is a flowchart of an image display method shown in an embodiment of the present application. This method may be performed by an image display apparatus provided by the present application, wherein the image display apparatus may be implemented by any software and/or hardware. For example, the image display apparatus may be configured in any electronic device, which may include, but is not limited to devices capable of displaying images, such as tablet computers, mobile phones (e.g., folding-screen mobile phones, large-screen mobile phones, etc.), wearable devices, vehicle-mounted devices, Augmented Reality (AR)/Virtual Reality (VR) devices, notebook computers, ultra-mobile personal computers (UMPCs), netbooks, Personal Digital Assistants (PDAs), smart televisions, smart screens, high definition televisions, 4K televisions, smart speakers, smart projectors, etc., and the specific type of the electronic device is not limited in the present application.

Specifically, as shown in FIG. 1, the method may comprise the following steps:

S110, determining, according to a pixel brightness of a to-be-displayed image, a corresponding adaptive brightness mapping relationship that makes a difference between the pixel brightness of a non-low-brightness pixel area of the to-be-displayed image after being displayed through an optical imaging system and an ideal brightness of the non-low-brightness pixel area that is not displayed through the optical imaging system less than a preset brightness difference.

In the field of image display, there are usually a variety of inherent hardware parameters related to image brightness that come with hardware design in an optical imaging system, such as the maximum and minimum brightness of a display panel, diffuse reflection of the display panel, ghost scattering of an optical module, face attachment light leakage, reflection and scattering of eye and face portions, and other related hardware design parameters. Then, when various images are displayed through the optical imaging system, the inherent hardware parameters described above will have certain influence on the original brightness of the images, thus increasing the lowest brightness in the images after image display, so that an in-eye contrast after image display is reduced to a certain extent (which indicates that the optical imaging system has the characteristic of image contrast attenuation), which affects the overall image quality of image display.

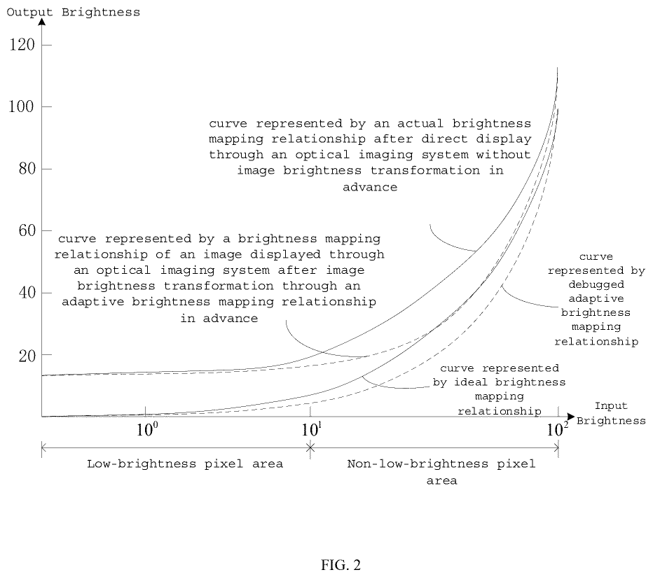

It can be seen that, for each image at different pixel brightness, there is an ideal brightness mapping relationship between an input brightness before image display and an output brightness after image display, when image display is not affected by the contrast reduction of the optical imaging system. As shown in FIG. 2, the ideal brightness mapping relationship may be a curve for representing a mapping relationship between the input brightness and the output brightness, and can ensure that the overall image quality of the image after being displayed without being affected by the contrast reduction of the optical imaging system can achieve the optimal picture visual effect, and can improve the definition of image display.

When image display is completed by introducing the contrast attenuation characteristic of the optical imaging system, the lowest brightness after image display is increased, so that the in-eye contrast after image display is reduced, and in this case, there will be an actual brightness mapping relationship between the input brightness before image display and the output brightness after image display through the optical imaging system. As shown in FIG. 2, the actual brightness mapping relationship may also be another curve for representing the mapping relationship between the input brightness and the output brightness, and can visually represent the brightness for the actual image quality of the image after being displayed under the influence of the contrast reduction of the optical imaging system. Moreover, if the overall picture brightness of the image is higher, the lowest brightness of image display through the optical imaging system will be significantly increased, so that the in-eye contrast after image display will be more significantly decreased, and then there will be a significant change in each actual brightness mapping relationship between the input brightness of each image under different pixel brightness before being displayed and the output brightness of the image after being displayed through the optical imaging system.

Thus, it is indicated that the brightness mapping relationship used when the image is displayed through the optical imaging system is related to the pixel brightness of the image.

Since the contrast attenuation characteristic of the optical imaging system is inherent in the related hardware design, subsequent efficient correction is generally not supported. That is, the increase of the lowest brightness of the image after being displayed through the optical imaging system cannot be avoided, so that a pixel brightness of a low-brightness pixel area of the image after being displayed through the optical imaging system cannot be greatly decreased to eliminate the image quality degradation effect due to the in-eye contrast reduction.

Therefore, in order to eliminate the image quality degradation effect due to the in-eye contrast reduction of the image after being displayed through the optical imaging system, in the present application, the pixel brightness in the non-low-brightness pixel area in the image can be adjusted to enable the pixel brightness of the non-low-brightness pixel area of the image after being displayed through the optical imaging system to be as close as possible to the corresponding output brightness of the image under the ideal brightness mapping relationship, thereby ensuring that the overall image quality of the image after being displayed through the optical imaging system can attain the optimal picture visual effect in the ideal state as far as possible, and eliminating the image quality degradation effect due to the in-eye contrast reduction of the image after being displayed through the optical imaging system.

Hence, in the present application, an ideal brightness mapping relationship can be determined, for images with different pixel brightness, by analyzing the optimal picture visual effect that can be achieved by the overall image quality after the images are displayed without being affected by the contrast reduction of the optical imaging system. Furthermore, by analyzing the input brightness of the images before being displayed and the output brightness of the images after being displayed through the optical imaging system, an actual brightness mapping relationship of the image when being displayed through the optical imaging system can be determined.

In the present application, in order to eliminate the image quality degradation effect due to the in-eye contrast reduction of images after being displayed through the optical imaging system, for image with each pixel brightness, a specific brightness mapping relationship can be debugged with reference to an ideal brightness mapping relationship when the image is displayed without being affected by the contrast reduction of the optical imaging system and an actual brightness mapping relationship after the image is displayed through the optical imaging system. The specific brightness mapping relationship may indicate that a difference between the pixel brightness of the non-low-brightness pixel area of the image after being displayed through the optical imaging system and the ideal brightness of the non-low-brightness pixel area that is not displayed through the optical imaging system is less than a preset brightness difference, so that the pixel brightness of the non-low-brightness pixel area of the image after being displayed through the optical imaging system can be as close as possible to the corresponding output brightness of the image under the ideal brightness mapping relationship.

In addition, the brightness of the image can be adjusted according to the specific brightness mapping relationship before the image is displayed through the optical imaging system, and then the adjusted image is displayed through the optical imaging system, thereby ensuring that a difference between the pixel brightness of the non-low-brightness pixel area of the image after being displayed through the optical imaging system and the ideal brightness of the non-low-brightness pixel area that is not displayed through the optical imaging system is less than a preset brightness difference, so that the pixel brightness of the non-low-brightness pixel area of the image after being displayed through the optical imaging system can be as close as possible to the corresponding output brightness of the image under the ideal brightness mapping relationship, whereby it is ensured that the overall image quality of the image after being displayed through the optical imaging system can achieve the optimal picture visual effect in the ideal state as far as possible.

As can be seen from the above, for different pixel brightness, a corresponding brightness mapping relationship can be debugged, so that a difference between the pixel brightness of the non-low-brightness pixel area of the image after being displayed through the optical imaging system and the ideal brightness of the non-low-brightness pixel area that is not displayed through the optical imaging system is made less than a preset brightness difference, thereby ensuring that the overall image quality of the image after being displayed through the optical imaging system can achieve the optimal picture visual effect in the ideal state as far as possible.

In addition, in order to ensure that the overall image quality of the image after being displayed through the optical imaging system can be the optimal, even if the increase of the lowest brightness of the image after being displayed through the optical imaging system cannot be avoided, for the low-brightness pixel area in the image, when the corresponding brightness mapping relationship is debugged, in the present application, the pixel brightness of the low-brightness pixel area of the image after being displayed through the optical imaging system can be made within a lowest brightness interval supported by the optical imaging system, with the brightness mapping relationship. The lowest brightness interval may be a minimum brightness change range that is increased by the optical imaging system due to the influence of hardware parameters on the lowest brightness of the image, so that the pixel brightness of the low-brightness pixel area of the image after being displayed through the optical imaging system can support, after being increased, only changes in the minimum brightness change range which cannot be avoided by the optical imaging system, thus retaining picture detail features in the low-brightness pixel area of the image as much as possible.

Therefore, the brightness mapping relationship debugged under different pixel brightness can not only make the pixel brightness of the low-brightness pixel area of the image after being displayed through the optical imaging system within the lowest brightness interval supported by the optical imaging system, but also make a difference between the pixel brightness of the non-low-brightness pixel area of the image after being displayed through the optical imaging system and the ideal brightness of the non-low-brightness pixel area that is not displayed through the optical imaging system less than a preset brightness difference. That is, with the brightness mapping relationship debugged under different pixel brightness, not only can picture details in the low-brightness pixel area of the image after being displayed through the optical imaging system be retained, but also it can be ensured that the pixel brightness in the non-low-brightness pixel area of the image after being displayed through the optical imaging system can be as close as possible to the output brightness of the image, under the ideal condition, which is not displayed through the optical imaging system, thus eliminating the image quality degradation effect due to the in-eye contrast reduction when the non-low-brightness pixel area of the image is displayed through the optical imaging system.

Then, for any to-be-displayed image, in the present application, brightness information of each pixel point in the to-be-displayed image can be analyzed first. Then, according to a pixel brightness of the to-be-displayed image, a brightness mapping relationship corresponding to the pixel brightness of the to-be-displayed image is determined from a plurality of brightness mapping relationships debugged in advance, as an adaptive brightness mapping relationship in the present application.

The adaptive brightness mapping relationship can make a difference between the pixel brightness of the non-low-brightness pixel area of the to-be-displayed image after being displayed through the optical imaging system and the ideal brightness of the non-low-brightness pixel area that is not displayed through the optical imaging system less than a preset brightness difference, so that the pixel brightness of the non-low-brightness pixel area of the to-be-displayed image after being displayed through the optical imaging system can be as close as possible to the output brightness of the to-be-displayed image, under the ideal condition, which is not displayed through the optical imaging system, whereby it is ensured that the overall image quality of the to-be-displayed image after being displayed through the optical imaging system can achieve the optimal picture visual effect in the ideal state as far as possible. Moreover, the adaptive brightness mapping relationship can also make the pixel brightness of the low-brightness pixel area of the to-be-displayed image after being displayed through the optical imaging system within a lowest brightness interval supported by the optical imaging system, thus retaining picture detail features in the low-brightness pixel area of the image as much as possible.

S120, transforming the pixel brightness of the to-be-displayed image according to the adaptive brightness mapping relationship, and displaying the transformed to-be-displayed image through the optical imaging system.

After the adaptive brightness mapping relationship corresponding to the to-be-displayed image is determined, in the present application, by transforming an input brightness of each pixel point in the to-be-displayed image using the relationship between an input brightness and an output brightness set in the adaptive brightness mapping relationship, an output brightness of each pixel point can be obtained, so that the pixel color (namely, RGB value) of the to-be-displayed image after brightness transformation is determined, thus obtaining the transformed to-be-displayed image.

Then, the transformed to-be-displayed image is processed through a variety of inherent hardware parameters related to image brightness that come with hardware design in the optical imaging system, so that normal display of the to-be-displayed image in a display panel of the optical imaging system can be completed, thereby ensuring that the image quality effect of the non-low-brightness pixel area of the to-be-displayed image after being displayed through the optical imaging system can be as close as possible to the ideal image quality effect of the to-be-displayed image that is not displayed through the optical imaging system, realizing efficient and clear display of the to-be-displayed image through the optical imaging system, and attaining the image quality effect similar to “image de-hazing”.

With the technical solution provided in the embodiment of the present application, for any to-be-displayed image, a corresponding adaptive brightness mapping relationship is first determined according to a pixel brightness of the to-be-displayed image, the pixel brightness of the to-be-displayed image is transformed accordingly, and the transformed to-be-displayed image is displayed through an optical imaging system, so that a difference between the pixel brightness of a non-low-brightness pixel area of the to-be-displayed image after being displayed through the optical imaging system and an ideal brightness of the non-low-brightness pixel area that is not displayed through the optical imaging system is less than a preset brightness difference, thereby ensuring that the image quality effect of the non-low-brightness pixel area of the to-be-displayed image after being displayed through the optical imaging system can be as close as possible to the ideal image quality effect of the to-be-displayed image that is not displayed through the optical imaging system, eliminating the image quality degradation effect due to the reduction of the in-eye contrast when the non-low-brightness pixel area of the to-be-displayed image is displayed through the optical imaging system, realizing efficient and clear display of the to-be-displayed image through the optical imaging system, attaining the image quality effect similar to “image de-hazing”, improving the overall image quality after image display and enhancing the visual effect of image display.

As an alternative implementation solution of the present application, considering that the electronic device of the present application that displays images through the optical imaging system is usually a Low Dynamic Range (LDR) display device, display of a limited dynamic range is supported. And the images can be classified into LDR images and High Dynamic Range (HDR) images.

Then, when an HDR image is displayed through an optical imaging system in the LDR display device, it is usually necessary to perform corresponding tone-mapping on the HDR image, so as to perform compression change on brightness information in the HDR image to display, so that a final display picture of the LDR display device can be as close as possible to the HDR image, thereby ensuring efficient display of the HDR image.

Therefore, in order to ensure the overall image quality after image display, the to-be-displayed image in the present application may be an LDR image or an HDR image after tone-mapping. Subsequently, using the corresponding brightness mapping relationship designed in the present application, the pixel brightness in the LDR image or the HDR image after tone-mapping continues to be transformed, so that the pixel brightness of the low-brightness pixel area of the to-be-displayed image after being displayed through the optical imaging system is made within the lowest brightness interval supported by the optical imaging system, and picture detail features in the low-brightness pixel area of the image are retained as much as possible. Furthermore, a difference between the pixel brightness of the non-low-brightness pixel area of the to-be-displayed image after being displayed through the optical imaging system and the ideal brightness of the non-low-brightness pixel area that is not displayed through the optical imaging system can be made less than a preset brightness difference, so that the pixel brightness of the non-low-brightness pixel area of the to-be-displayed image after being displayed through the optical imaging system can be as close as possible to the output brightness of the to-be-displayed image, under the ideal condition, which is not displayed through the optical imaging system, whereby it is ensured that the overall image quality of the to-be-displayed image after being displayed through the optical imaging system can achieve the optimal picture visual effect in the ideal state as far as possible.

In the present application, for different pixel brightness, a corresponding brightness mapping relationship is debugged in advance. Then, by combining the debugged brightness mapping relationships under different pixel brightness, a corresponding brightness mapping relationship library can be constructed. The brightness mapping relationship library can respectively store, according to each pixel brightness, a brightness mapping relationship debugged in advance under the pixel brightness.

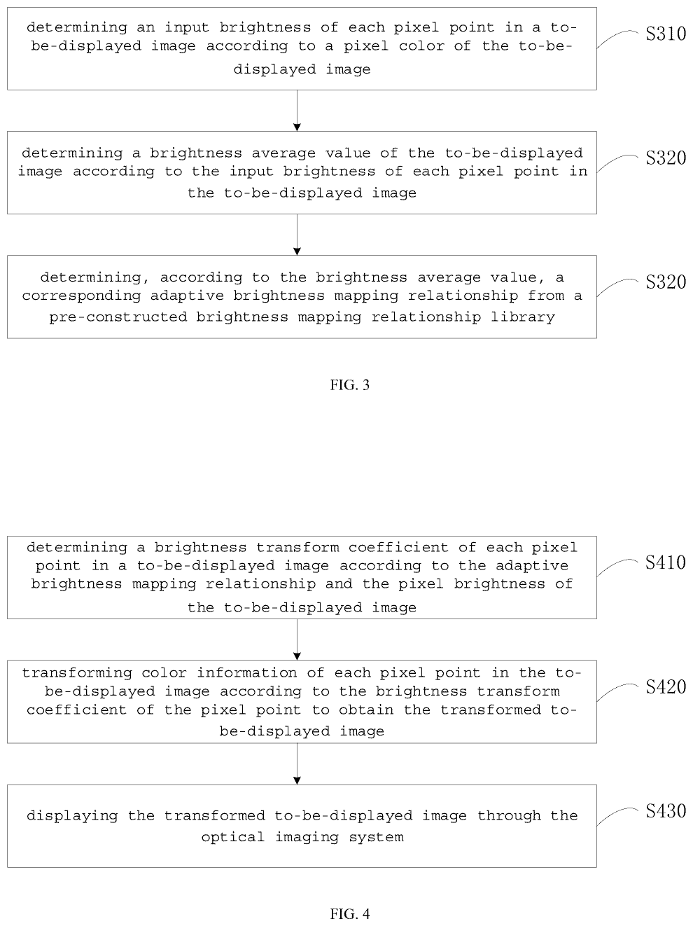

Then, as shown in FIG. 3, for the adaptive brightness mapping relationship in the present application, it can be determined by the following steps:

S310, determining an input brightness of each pixel point in the to-be-displayed image according to a pixel color of the to-be-displayed image.

Since the to-be-displayed image is usually represented using an RGB color space model, in the present application, RGB color information of each pixel point in the to-be-displayed image can be first acquired, so as to obtain the pixel color of the to-be-displayed image.

Considering that the brightness mapping relationship debugged in advance for each image is generally related to the pixel brightness of the image, and storage of images may generally be divided into an RGB color space model and a YUV color space model, in the present application, color information of each pixel point in the to-be-displayed image can be transformed into the YUV format, and according to the Y value of each pixel point, the input brightness of each pixel point in the to-be-displayed image can be obtained.

The transformation formula of the to-be-displayed image from the RGB format to the YUV format may be as follows:

$$\{ \begin{matrix}Y = 0.299 * R + 0.587 * G + 0.114 * B \\ U = - 0.147 * R - 0.289 * G + 0.436 * B \\ V = 0.615 * R - 0.515 * G - 0.1 * B\end{matrix}$$

S320, determining a brightness average value of the to-be-displayed image according to the input brightness of each pixel point in the to-be-displayed image.

After the input brightness of each pixel point in the to-be-displayed image is determined, the sum of the input brightness of each pixel point in the to-be-displayed image can be determined. Then, according to the number of pixel points in the to-be-displayed image, the brightness average value of the to-be-displayed image can be determined, which can represent the overall brightness condition of the to-be-displayed image, thereby analyzing the adaptive brightness mapping relationship corresponding to the to-be-displayed image.

S330, determining, according to the brightness average value, a corresponding adaptive brightness mapping relationship from a pre-constructed brightness mapping relationship library.

In order to ensure the orderliness of the pre-constructed brightness mapping relationship library, a brightness mapping relationship debugged in advance for each image can be respectively stored in the pre-constructed brightness mapping relationship library, using a brightness average value capable of representing the overall brightness condition of each image.

Thus, after the brightness average value of the to-be-displayed image is determined, a brightness mapping relationship corresponding to the brightness average value can be found from the pre-constructed brightness mapping relationship library according to the brightness average value, as the adaptive brightness mapping relationship in the present application.

In another implementation, in addition to being affected by the variety of inherent hardware parameters related to image brightness that come with hardware design in the optical imaging system, the in-eye contrast of an image is further affected by a ratio between a white area and a black area in the image.

Since the variety of inherent hardware parameters related to image brightness that come with hardware design in the optical imaging system are configured during hardware design and do not support correction, and the ratio between the white area and the black area in the image can be represented by the brightness average value of the image, the in-eye contrast of the image can be uniquely correlated with the brightness average value of the image.

Then, a brightness mapping relationship debugged in advance for each image can be respectively stored in the pre-constructed brightness mapping relationship library according to a brightness average value of each image, and in addition, a corresponding in-eye contrast can be calculated according to the brightness average value of each image, and the brightness mapping relationship debugged in advance for each image can be respectively stored in the pre-constructed brightness mapping relationship library according to the in-eye contrast of each image.

Thus, determining the corresponding adaptive brightness mapping relationship from the pre-constructed brightness mapping relationship library according to the brightness average value may further comprise the steps of: determining an in-eye contrast of the to-be-displayed image according to the brightness average value and brightness related hardware parameters of the optical imaging system; and determining the corresponding adaptive brightness mapping relationship from the pre-constructed brightness mapping relationship library according to the in-eye contrast.

That is, if a brightness mapping relationship debugged in advance for each image is respectively stored in the pre-constructed brightness mapping relationship library according to the in-eye contrast of each image, then after determining the brightness average value of the to-be-displayed image, the variety of inherent hardware parameters related to image brightness that come with hardware design in the optical imaging system can be acquired, thus obtaining the brightness related hardware parameters of the optical imaging system.

After that, the in-eye contrast of the to-be-displayed image can be calculated by comprehensively analyzing the brightness average value of the to-be-displayed image and the brightness related hardware parameters of the optical imaging system.

Illustratively, the in-eye contrast of the to-be-displayed image may be expressed as f_{CR}(S, F, Lₘᵢₙ, Lₘₐₓ, Lₖ)
where is a scattering coefficient of a display panel in the optical imaging system, Lₘᵢₙ is a minimum brightness of the display panel at the time of displaying a full black picture, Lₘₐₓ is a maximum brightness of the display panel at the time of displaying a full white picture, and Lₖ is face attachment light leakage and reflection and scattering of face and eye portions related to ambient light, all of which belong to the brightness related hardware parameters of the optical imaging system.

And F may be a ratio between the white area and the black area in the to-be-displayed image, which can be represented by the brightness average value of the to-be-displayed image.

Furthermore, after the in-eye contrast of the to-be-displayed image is determined, a brightness mapping relationship corresponding to the in-eye contrast can be found from the pre-constructed brightness mapping relationship library according to the in-eye contrast, as the adaptive brightness mapping relationship in the present application.

It should be noted that, due to a large number of images with different pixel brightness, there are also a large number of specific values for the brightness average value and the in-eye contrast of the image. Then, in order to ensure high efficiency and simplicity of the brightness mapping relationship library, a corresponding brightness mapping relationship is not debugged for storage under all brightness average values or all in-eye contrasts in the present application. Instead, a corresponding brightness mapping relationship is debugged for a specific portion of brightness average values or portion of in-eye contrasts (for example, the brightness average values are special values such as 0.1, 0.2, 0.3, etc.), and it is stored in the brightness mapping relationship library according to the specific portion of brightness average values or portion of in-eye contrasts.

Hence, for the brightness average value or the in-eye contrast of the to-be-displayed image, the corresponding adaptive brightness mapping relationship may not be directly found from the pre-constructed brightness mapping relationship library. In this case, determining the corresponding adaptive brightness mapping relationship from the pre-constructed brightness mapping relationship library, either according to the brightness average value or according to the in-eye contrast, may specifically be: determining at least two associated brightness and a brightness mapping relationship corresponding to the associated brightness from the pre-constructed brightness mapping relationship library according to the brightness average value of the to-be-displayed image; or, determining at least two associated contrasts and a brightness mapping relationship corresponding to the associated contrasts from the pre-constructed brightness mapping relationship library according to the in-eye contrast of the to-be-displayed image; and determining the corresponding adaptive brightness mapping relationship by performing brightness interpolation on the brightness mapping relationship corresponding to the at least two associated brightness or the at least two associated contrasts.

That is, for determining the corresponding adaptive brightness mapping relationship from the pre-constructed brightness mapping relationship library according to the brightness average value, at least two brightness average values that are closest to the brightness average value can be first determined from the brightness average values corresponding to the brightness mapping relationships stored in the pre-constructed brightness mapping relationship library as the associated brightness in the present application. And by determining a corresponding brightness mapping relationship debugged in advance for each associated brightness from the pre-constructed brightness mapping relationship library, a brightness mapping relationship corresponding to each associated brightness can be obtained.

Then, according to the relationship between the brightness average value of the to-be-displayed image and the at least two associated brightness, at least two output brightness corresponding to the same input brightness in the brightness mapping relationship corresponding to the at least two associated brightness can be interpolated in a 2D-LUT interpolation mode, so as to obtain the output brightness corresponding to the input brightness under the brightness average value of the to-be-displayed image, thereby obtaining a brightness mapping relationship corresponding to the brightness average value of the to-be-displayed image, as the adaptive brightness mapping relationship in the present application.

Alternatively, for determining the corresponding adaptive brightness mapping relationship from the pre-constructed brightness mapping relationship library according to the in-eye contrast, at least two in-eye contrasts that are closest to the in-eye contrast of the to-be-displayed image can be first determined from the in-eye contrasts corresponding to the brightness mapping relationships stored in the pre-constructed brightness mapping relationship library as the associated contrasts in the present application. And by determining a corresponding brightness mapping relationship debugged in advance for each associated contrast from the pre-constructed brightness mapping relationship library, a brightness mapping relationship corresponding to each associated contrast can be obtained.

Then, according to the relationship between the in-eye contrast of the to-be-displayed image and the at least two associated contrasts, at least two output brightness corresponding to the same input brightness in the brightness mapping relationship corresponding to the at least two associated contrasts can be interpolated in a 2D-LUT interpolation mode, so as to obtain the output brightness corresponding to the input brightness under the in-eye contrast of the to-be-displayed image, thereby obtaining a brightness mapping relationship corresponding to the in-eye contrast of the to-be-displayed image, as the adaptive brightness mapping relationship in the present application.

According to one or more embodiments of the present application, after determining the adaptive brightness mapping relationship corresponding to the to-be-displayed image, in order to realize efficient and clear display of the to-be-displayed image through the optical imaging system, the pixel brightness transformation process and the image display process of the to-be-displayed image can be described in detail in the present application.

FIG. 4 is a method flowchart of a display process of a to-be-displayed image shown in an embodiment of the present application. As shown in FIG. 4, the method may specifically comprise the following steps:

S410, determining a brightness transform coefficient of each pixel point in the to-be-displayed image according to the adaptive brightness mapping relationship and the pixel brightness of the to-be-displayed image.

After the adaptive brightness mapping relationship corresponding to the to-be-displayed image is determined, the brightness transform coefficient of each pixel point can be determined from the adaptive brightness mapping relationship according to brightness information of each pixel point in the to-be-displayed image, and therefore corresponding brightness transformation is carried out on each pixel point.

In some implementations, the brightness transform coefficient of each pixel point in the to-be-displayed image may be determined by the steps of: determining an output brightness of each pixel point in the to-be-displayed image according to the adaptive brightness mapping relationship and an input brightness of each pixel point in the to-be-displayed image; and determining a ratio between the output brightness and the input brightness of each pixel point in the to-be-displayed image as the brightness transform coefficient of the pixel point.

That is, by analyzing the input brightness of each pixel point in the to-be-displayed image, in the present application, the input brightness of each pixel point can be transformed using the adaptive brightness mapping relationship to obtain the output brightness of each pixel point. Then, the ratio between the output brightness and the input brightness of each pixel point in the to-be-displayed image is used as the brightness transform coefficient of the pixel point, thereby obtaining the brightness transform coefficient of each pixel point.

Illustratively, the brightness transform coefficient of each pixel point may be represented as

$$\frac{{Y}_{output}}{{Y}_{input}} ,$$

where Yᵢₙₚᵤₜ may be an input brightness of the pixel point, and Yₒᵤₜₚᵤₜ may be an output brightness of the pixel point after being adjusted using the brightness mapping relationship.

S420, transforming color information of each pixel point in the to-be-displayed image according to the brightness transform coefficient of the pixel point to obtain the transformed to-be-displayed image.

The pixel color in the to-be-displayed image has the same transformation relationship as the pixel brightness. Thus, after the brightness transform coefficient of each pixel point in the to-be-displayed image is determined, in the present application, the brightness transform coefficient of the pixel point can be directly used to transform the color information of the pixel point, to obtain the pixel color of each pixel point after color transformation, thereby obtaining the transformed to-be-displayed image.

Illustratively, the color information of each pixel point in the transformed to-be-displayed image may be:

$$[ \begin{matrix}{r}^{′} \\ {g}^{′} \\ {b}^{′}\end{matrix} ] = \frac{{Y}_{output}}{{Y}_{input}} [ \begin{matrix}r \\ g \\ b\end{matrix} ] .$$

In another case, the color transformation of each pixel point in the to-be-displayed image can be further performed, in the present application, by: determining, when the brightness transform coefficient of each pixel point in the to-be-displayed image is determined, the output brightness Yₒᵤₜₚᵤₜ of each pixel point in the to-be-displayed image, of the input brightness Yᵢₙₚᵤₜ, subject to the adaptive brightness mapping relationship transformation. And chrominance information (namely the UV value in the YUV format) of each pixel point in the to-be-displayed image does not change.

Therefore, the color information of each pixel point in the to-be-displayed image, which is represented in a YUV format after transformation using the adaptive brightness mapping relationship, can be obtained. Then, in the present application, by continuing to transform the color information of each pixel point in the to-be-displayed image in the YUV format back to the RGB format, the pixel color of each pixel point after color transformation can be obtained, thereby obtaining the transformed to-be-displayed image.

The transformation formula of the to-be-displayed image from the YUV format to the RGB format may be as follows:

$$\{ \begin{matrix}R = Y + 0.14 * V \\ G = Y - 0.394 * U - 0.581 * V \\ B = Y + 2.032 * U\end{matrix}$$

S430, displaying the transformed to-be-displayed image through the optical imaging system.

After the transformed to-be-displayed image is obtained, the transformed to-be-displayed image can be displayed through the optical imaging system; at this time, the transformed to-be-displayed image is processed through a variety of inherent hardware parameters related to image brightness that come with hardware design in the optical imaging system, so that normal display of the to-be-displayed image in a display panel of the optical imaging system can be completed, thereby ensuring that the image quality effect of the non-low-brightness pixel area of the to-be-displayed image after being displayed through the optical imaging system can be as close as possible to the ideal image quality effect of the to-be-displayed image that is not displayed through the optical imaging system, realizing efficient and clear display of the to-be-displayed image through the optical imaging system, and attaining the image quality effect similar to “image de-hazing”.

With the technical solution provided in the embodiment of the present application, before displaying the to-be-displayed image through the optical imaging system, the pixel color of the to-be-displayed image can be transformed in advance according to the adaptive brightness mapping relationship corresponding to the to-be-displayed image, and the transformed to-be-displayed image is displayed through the optical imaging system, so that a difference between the pixel brightness of a non-low-brightness pixel area of the to-be-displayed image after being displayed through the optical imaging system and an ideal brightness of the non-low-brightness pixel area that is not displayed through the optical imaging system is less than a preset brightness difference, thereby ensuring that the image quality effect of the non-low-brightness pixel area of the to-be-displayed image after being displayed through the optical imaging system can be as close as possible to the ideal image quality effect of the to-be-displayed image that is not displayed through the optical imaging system, eliminating the image quality degradation effect due to the reduction of the in-eye contrast when the non-low-brightness pixel area of the to-be-displayed image is displayed through the optical imaging system, realizing efficient and clear display of the to-be-displayed image through the optical imaging system, attaining the image quality effect similar to “image de-hazing”, improving the overall image quality after image display and enhancing the visual effect of image display.

FIG. 5 is a principle block diagram of an image display apparatus shown in an embodiment of the present application. As shown in FIG. 5, the image display apparatus 500 may comprise:
a mapping relationship determination module 510 configured to determine, according to a pixel brightness of a to-be-displayed image, a corresponding adaptive brightness mapping relationship that makes a difference between the pixel brightness of a non-low-brightness pixel area of the to-be-displayed image after being displayed through an optical imaging system and an ideal brightness of the non-low-brightness pixel area that is not displayed through the optical imaging system less than a preset brightness difference; and
an image display module 520 configured to transform the pixel brightness of the to-be-displayed image according to the adaptive brightness mapping relationship, and display the transformed to-be-displayed image through the optical imaging system.

In some implementations, the adaptive brightness mapping relationship makes a pixel brightness of a low-brightness pixel area of the to-be-displayed image after being displayed through the optical imaging system within a lowest brightness interval supported by the optical imaging system.

In some implementations, the mapping relationship determination module 510 may comprise:
an input brightness determination unit configured to determine an input brightness of each pixel point in the to-be-displayed image according to a pixel color of the to-be-displayed image;
a brightness average value determination unit configured to determine a brightness average value of the to-be-displayed image according to the input brightness of each pixel point in the to-be-displayed image; and
a mapping relationship determination unit configured to determine the corresponding adaptive brightness mapping relationship from a pre-constructed brightness mapping relationship library according to the brightness average value.

In some implementations, the mapping relationship determination unit may be specifically configured to:
determine an in-eye contrast of the to-be-displayed image according to the brightness average value and brightness related hardware parameters of the optical imaging system; and
determine the corresponding adaptive brightness mapping relationship from the pre-constructed brightness mapping relationship library according to the in-eye contrast.

In some implementations, the mapping relationship determination unit may be further specifically configured to:
determine at least two associated brightness and a brightness mapping relationship corresponding to the associated brightness from the pre-constructed brightness mapping relationship library according to the brightness average value of the to-be-displayed image; or,
determine at least two associated contrasts and a brightness mapping relationship corresponding to the associated contrasts from the pre-constructed brightness mapping relationship library according to the in-eye contrast of the to-be-displayed image; and
determine the corresponding adaptive brightness mapping relationship by performing brightness interpolation on the brightness mapping relationship corresponding to the at least two associated brightness or the at least two associated contrasts.

In some implementations, the image display module 520 may comprise:
a transform coefficient determination unit configured to determine a brightness transform coefficient of each pixel point in the to-be-displayed image according to the adaptive brightness mapping relationship and the pixel brightness of the to-be-displayed image;
a pixel color transformation unit configured to transform color information of each pixel point in the to-be-displayed image according to the brightness transform coefficient of the pixel point to obtain the transformed to-be-displayed image; and
an image display unit configured to display the transformed to-be-displayed image through the optical imaging system.

In some implementations, the transform coefficient determination unit may be specifically configured to:
determine an output brightness of each pixel point in the to-be-displayed image according to the adaptive brightness mapping relationship and an input brightness of each pixel point in the to-be-displayed image; and
determine a ratio between the output brightness and the input brightness of each pixel point in the to-be-displayed image as the brightness transform coefficient of the pixel point.

In some implementations, the to-be-displayed image is a low dynamic range LDR image or a tone-mapped high dynamic range HDR image.

In the embodiment of the present application, for any to-be-displayed image, a corresponding adaptive brightness mapping relationship is first determined according to a pixel brightness of the to-be-displayed image, the pixel brightness of the to-be-displayed image is transformed accordingly, and the transformed to-be-displayed image is displayed through an optical imaging system, so that a difference between the pixel brightness of a non-low-brightness pixel area of the to-be-displayed image after being displayed through the optical imaging system and an ideal brightness of the non-low-brightness pixel area that is not displayed through the optical imaging system is less than a preset brightness difference, thereby ensuring that the image quality effect of the non-low-brightness pixel area of the to-be-displayed image after being displayed through the optical imaging system can be as close as possible to the ideal image quality effect of the to-be-displayed image that is not displayed through the optical imaging system, eliminating the image quality degradation effect due to the reduction of the in-eye contrast when the non-low-brightness pixel area of the to-be-displayed image is displayed through the optical imaging system, realizing efficient and clear display of the to-be-displayed image through the optical imaging system, attaining the image quality effect similar to “image de-hazing”, improving the overall image quality after image display and enhancing the visual effect of image display.

It is to be understood that the apparatus embodiments may correspond to the method embodiments of the present application and that similar description may be made with reference to the method embodiments of the present application. To avoid repetition, the description is omitted here.

Specifically, the apparatus 500 shown in FIG. 5 may perform any method embodiment provided by the present application, and the foregoing and other operations and/or functions of respective modules in the apparatus 500 shown in FIG. 5 are respectively for implementing respective flows of the above method embodiments, and are not described herein again for brevity.

The above method embodiments in the embodiments of the present application are described above from the perspective of functional modules in conjunction with the accompanying drawings. It should be understood that the functional modules may be implemented by hardware, by instructions in the form of software, or by a combination of hardware and software modules. Specifically, the steps of the method embodiments in the embodiments of the present application may be implemented by integrated logic circuits of hardware in a processor and/or instructions in the form of software, and the steps of the method disclosed in the embodiments of the present application may be directly implemented by a hardware decoding processor, or implemented by a combination of hardware and software modules in the decoding processor. Alternatively, the software modules may be located in a mature storage medium in the art, such as a random access memory, a flash memory, a read only memory, a programmable read only memory, an electrically erasable programmable memory, a register, or the like. The storage medium is located in a memory, and a processor reads information in the memory and completes the steps of the above method embodiments in conjunction with hardware thereof.

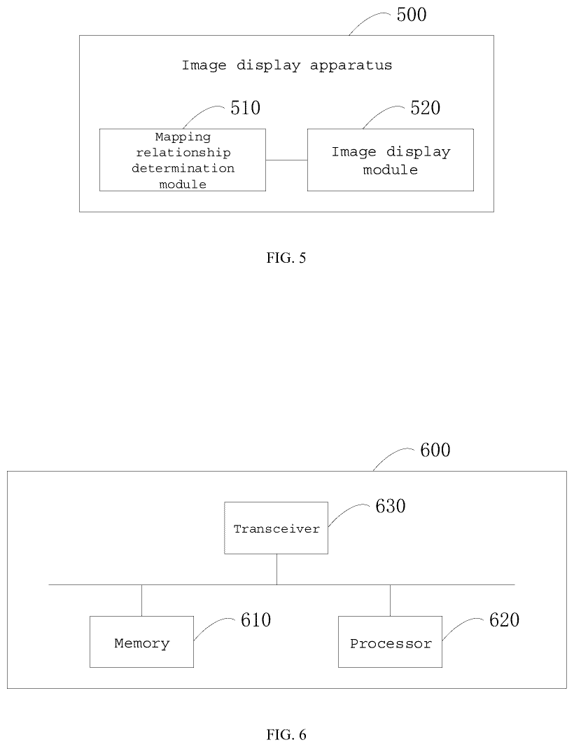

FIG. 6 is a schematic block diagram of an electronic device shown in an embodiment of the present application.

As shown in FIG. 6, the electronic device 600 may comprise:
a memory 610 and a processor 620, the memory 610 being configured to store a computer program and transfer the program code to the processor 620. In other words, the processor 620 may call the computer program from the memory 610 and run it to implement the method in the embodiment of the present application.

For example, the processor 620 may be configured to perform the above-described method embodiments according to instructions in the computer program.

In some embodiments of the present application, the processor 620 may include, but is not limited to:
a general purpose processor, a Digital Signal Processor (DSP), an Application Specific Integrated Circuit (ASIC), a Field Programmable Gate Array (FPGA) or other Programmable logic device, a discrete gate or transistor logic device, a discrete hardware component, and the like.

In some embodiments of the present application, the memory 610 includes, but is not limited to:
a volatile memory and/or a non-volatile memory, wherein the non-volatile memory may be a Read-Only Memory (ROM), a Programmable ROM (PROM), an Erasable PROM (EPROM), an Electrically Erasable PROM (EEPROM), or a flash Memory; the volatile memory may be a Random Access Memory (RAM) which serves as an external cache. By way of example and not limitation, many forms of RAM are available, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a synch link DRAM (SLDRAM), and a Direct Rambus RAM (DR RAM).

In some embodiments of the present application, the computer program may be partitioned into one or more modules, which are stored in the memory 610 and executed by the processor 620, to complete the method provided by the application. The one or more modules may be a series of computer program instruction segments capable of performing certain functions, the instruction segments being used to describe the execution process of the computer program in the electronic device 600.

As shown in FIG. 6, the electronic device may further comprise:
a transceiver 630, which may be connected to the processor 620 or the memory 610.

The processor 620 may control the transceiver 630 to communicate with other devices, and specifically, to transmit information or data to the other devices or receive information or data transmitted from the other devices. The transceiver 630 may include a transmitter and a receiver. The transceiver 630 may further include an antenna, the number of which may be one or more.

It should be understood that the various components in the electronic device 600 are connected via a bus system that includes a power bus, a control bus, and a status signal bus in addition to a data bus.

The present application further provides a computer storage medium having stored thereon a computer program which, when executed by a computer, enables the computer to perform the method of the above method embodiments.

The embodiments of the present application further provide a computer program product including a computer program/instructions, which, when executed by a computer, cause the computer to perform the method of the above method embodiments.

When implemented using software, it may be implemented in whole or in part in the form of a computer program product. The computer program product includes one or more computer instructions. The procedures or functions described in accordance with the embodiments of the present application may be generated in whole or in part by loading and executing the computer program instructions on a computer. The computer may be a general purpose computer, a special purpose computer, a network of computers, or other programmable device. The computer instructions may be stored on a computer-readable storage medium, or transmitted from one computer-readable storage medium to another computer-readable storage medium, for example, the computer instructions may be transmitted from one website, computer, server, or data center to another website, computer, server, or data center in a wired (e.g., coaxial cable, fiber optic, digital subscriber line (DSL)) or wireless (e.g., infrared, wireless, microwave, etc.) manner. The computer-readable storage medium may be any available medium that can be accessed by a computer or a data storage device such as a server or a data center integrated with one or more available media. The available medium may be a magnetic medium (e.g., a floppy disk, a hard disk, a magnetic tape), an optical medium (e.g., a digital video disc (DVD)), or a semiconductor medium (e.g., a solid state disk (SSD)), among others.

The above description is only for the specific embodiments of the present application, but the protection scope of the present application is not limited thereto, and any person skilled in the art can easily conceive of variations or substitutions within the technical scope of the present application revealed by the present application, which should be covered within the protection scope of the present application. Therefore, the protection scope of the present application should be based on the protection scope of the claims.

What is claimed is:

1. An image display method, comprising:
determining, according to a pixel brightness of a to-be-displayed image, a corresponding adaptive brightness mapping relationship that makes a difference between the pixel brightness of a non-low-brightness pixel area of the to-be-displayed image after being displayed through an optical imaging system and an ideal brightness of the non-low-brightness pixel area that is not displayed through the optical imaging system less than a preset brightness difference; and
transforming the pixel brightness of the to-be-displayed image according to the adaptive brightness mapping relationship, and displaying the transformed to-be-displayed image through the optical imaging system.

2. The method according to claim 1, wherein the adaptive brightness mapping relationship makes a pixel brightness of a low-brightness pixel area of the to-be-displayed image after being displayed through the optical imaging system within a lowest brightness interval supported by the optical imaging system.

3. The method according to claim 1, wherein the determining, according to a pixel brightness of a to-be-displayed image, a corresponding adaptive brightness mapping relationship comprises:
determining an input brightness of each pixel point in the to-be-displayed image according to a pixel color of the to-be-displayed image;
determining a brightness average value of the to-be-displayed image according to the input brightness of each pixel point in the to-be-displayed image; and
determining the corresponding adaptive brightness mapping relationship from a pre-constructed brightness mapping relationship library according to the brightness average value.

4. The method according to claim 3, wherein the determining the corresponding adaptive brightness mapping relationship from a pre-constructed brightness mapping relationship library according to the brightness average value comprises:
determining an in-eye contrast of the to-be-displayed image according to the brightness average value and brightness related hardware parameters of the optical imaging system; and
determining the corresponding adaptive brightness mapping relationship from the pre-constructed brightness mapping relationship library according to the in-eye contrast.

5. The method according to claim 3, wherein the determining the corresponding adaptive brightness mapping relationship from the pre-constructed brightness mapping relationship library comprises:
determining at least two associated brightness and a brightness mapping relationship corresponding to the associated brightness from the pre-constructed brightness mapping relationship library according to the brightness average value of the to-be-displayed image; or,
determining at least two associated contrasts and a brightness mapping relationship corresponding to the associated contrasts from the pre-constructed brightness mapping relationship library according to the in-eye contrast of the to-be-displayed image; and
determining the corresponding adaptive brightness mapping relationship by performing brightness interpolation on the brightness mapping relationship corresponding to the at least two associated brightness or the at least two associated contrasts.

6. The method according to claim 1, wherein the transforming the pixel brightness of the to-be-displayed image according to the adaptive brightness mapping relationship, and displaying the transformed to-be-displayed image through the optical imaging system comprises:
determining a brightness transform coefficient of each pixel point in the to-be-displayed image according to the adaptive brightness mapping relationship and the pixel brightness of the to-be-displayed image;
transforming color information of each pixel point in the to-be-displayed image according to the brightness transform coefficient of the pixel point to obtain the transformed to-be-displayed image; and
displaying the transformed to-be-displayed image through the optical imaging system.

7. The method according to claim 6, wherein the determining a brightness transform coefficient of each pixel point in the to-be-displayed image according to the adaptive brightness mapping relationship and the pixel brightness of the to-be-displayed image comprises:
determining an output brightness of each pixel point in the to-be-displayed image according to the adaptive brightness mapping relationship and an input brightness of each pixel point in the to-be-displayed image; and
determining a ratio between the output brightness and the input brightness of each pixel point in the to-be-displayed image as the brightness transform coefficient of the pixel point.

8. The method according to claim 1, wherein the to-be-displayed image is a low dynamic range LDR image or a tone-mapped high dynamic range HDR image.

9. An electronic device, comprising:
a processor; and
a memory configured to store executable instructions of the processor;
wherein the processor is configured to perform, by executing the executable instructions, an image display method comprising:
determining, according to a pixel brightness of a to-be-displayed image, a corresponding adaptive brightness mapping relationship that makes a difference between the pixel brightness of a non-low-brightness pixel area of the to-be-displayed image after being displayed through an optical imaging system and an ideal brightness of the non-low-brightness pixel area that is not displayed through the optical imaging system less than a preset brightness difference; and
transforming the pixel brightness of the to-be-displayed image according to the adaptive brightness mapping relationship, and displaying the transformed to-be-displayed image through the optical imaging system.

10. The electronic device according to claim 9, wherein the adaptive brightness mapping relationship makes a pixel brightness of a low-brightness pixel area of the to-be-displayed image after being displayed through the optical imaging system within a lowest brightness interval supported by the optical imaging system.

11. The electronic device according to claim 9, wherein the determining, according to a pixel brightness of a to-be-displayed image, a corresponding adaptive brightness mapping relationship comprises:
determining an input brightness of each pixel point in the to-be-displayed image according to a pixel color of the to-be-displayed image;
determining a brightness average value of the to-be-displayed image according to the input brightness of each pixel point in the to-be-displayed image; and
determining the corresponding adaptive brightness mapping relationship from a pre-constructed brightness mapping relationship library according to the brightness average value.

12. The electronic device according to claim 11, wherein the determining the corresponding adaptive brightness mapping relationship from a pre-constructed brightness mapping relationship library according to the brightness average value comprises:
determining an in-eye contrast of the to-be-displayed image according to the brightness average value and brightness related hardware parameters of the optical imaging system; and
determining the corresponding adaptive brightness mapping relationship from the pre-constructed brightness mapping relationship library according to the in-eye contrast.

13. The electronic device according to claim 11, wherein the determining the corresponding adaptive brightness mapping relationship from the pre-constructed brightness mapping relationship library comprises:
determining at least two associated brightness and a brightness mapping relationship corresponding to the associated brightness from the pre-constructed brightness mapping relationship library according to the brightness average value of the to-be-displayed image; or,
determining at least two associated contrasts and a brightness mapping relationship corresponding to the associated contrasts from the pre-constructed brightness mapping relationship library according to the in-eye contrast of the to-be-displayed image; and
determining the corresponding adaptive brightness mapping relationship by performing brightness interpolation on the brightness mapping relationship corresponding to the at least two associated brightness or the at least two associated contrasts.

14. The electronic device according to claim 9, wherein the transforming the pixel brightness of the to-be-displayed image according to the adaptive brightness mapping relationship, and displaying the transformed to-be-displayed image through the optical imaging system comprises:
determining a brightness transform coefficient of each pixel point in the to-be-displayed image according to the adaptive brightness mapping relationship and the pixel brightness of the to-be-displayed image;
transforming color information of each pixel point in the to-be-displayed image according to the brightness transform coefficient of the pixel point to obtain the transformed to-be-displayed image; and
displaying the transformed to-be-displayed image through the optical imaging system.

15. A non-transitory computer-readable storage medium storing a computer program thereon, wherein the computer program, when executed by a processor, implements an image display method comprising:
determining, according to a pixel brightness of a to-be-displayed image, a corresponding adaptive brightness mapping relationship that makes a difference between the pixel brightness of a non-low-brightness pixel area of the to-be-displayed image after being displayed through an optical imaging system and an ideal brightness of the non-low-brightness pixel area that is not displayed through the optical imaging system less than a preset brightness difference; and
transforming the pixel brightness of the to-be-displayed image according to the adaptive brightness mapping relationship, and displaying the transformed to-be-displayed image through the optical imaging system.

16. The non-transitory computer-readable storage medium according to claim 15, wherein the adaptive brightness mapping relationship makes a pixel brightness of a low-brightness pixel area of the to-be-displayed image after being displayed through the optical imaging system within a lowest brightness interval supported by the optical imaging system.

17. The non-transitory computer-readable storage medium according to claim 15, wherein the determining, according to a pixel brightness of a to-be-displayed image, a corresponding adaptive brightness mapping relationship comprises:
determining an input brightness of each pixel point in the to-be-displayed image according to a pixel color of the to-be-displayed image;
determining a brightness average value of the to-be-displayed image according to the input brightness of each pixel point in the to-be-displayed image; and
determining the corresponding adaptive brightness mapping relationship from a pre-constructed brightness mapping relationship library according to the brightness average value.

18. The non-transitory computer-readable storage medium according to claim 17, wherein the determining the corresponding adaptive brightness mapping relationship from a pre-constructed brightness mapping relationship library according to the brightness average value comprises:
determining an in-eye contrast of the to-be-displayed image according to the brightness average value and brightness related hardware parameters of the optical imaging system; and
determining the corresponding adaptive brightness mapping relationship from the pre-constructed brightness mapping relationship library according to the in-eye contrast.

19. The non-transitory computer-readable storage medium according to claim 17, wherein the determining the corresponding adaptive brightness mapping relationship from the pre-constructed brightness mapping relationship library comprises:
determining at least two associated brightness and a brightness mapping relationship corresponding to the associated brightness from the pre-constructed brightness mapping relationship library according to the brightness average value of the to-be-displayed image; or,
determining at least two associated contrasts and a brightness mapping relationship corresponding to the associated contrasts from the pre-constructed brightness mapping relationship library according to the in-eye contrast of the to-be-displayed image; and
determining the corresponding adaptive brightness mapping relationship by performing brightness interpolation on the brightness mapping relationship corresponding to the at least two associated brightness or the at least two associated contrasts.

20. The non-transitory computer-readable storage medium according to claim 15, wherein the transforming the pixel brightness of the to-be-displayed image according to the adaptive brightness mapping relationship, and displaying the transformed to-be-displayed image through the optical imaging system comprises:
determining a brightness transform coefficient of each pixel point in the to-be-displayed image according to the adaptive brightness mapping relationship and the pixel brightness of the to-be-displayed image;
transforming color information of each pixel point in the to-be-displayed image according to the brightness transform coefficient of the pixel point to obtain the transformed to-be-displayed image; and
displaying the transformed to-be-displayed image through the optical imaging system.
